(19) United States
(12) Patent Application Publication
(10) Pub. No.: US 2017/0024119 A1
(43) Pub. Date: Jan. 26, 2017

(54) USER INTERFACE AND METHOD FOR CONTROLLING A VOLUME BY MEANS OF A TOUCH-SENSITIVE DISPLAY UNIT

(71) Applicant: VOLKSWAGEN AKTIENGESELLSCHAFT, Wolfsburg (DE)

(72) Inventors: Holger WILD, Berlin (DE); Mark Peter CZELNIK, Wolfsburg (DE)

(21) Appl. No.: 15/112,687

(22) PCT Filed: Jan. 20, 2014
(86) PCT No.: PCT/EP2014/051056

§ 371 Date: Oct. 5, 2016

(51) Int. Cl. G06F 3/0488; G06F 3/16; G06F 3/0482; B60K 37/06

(52) U.S. Cl. CPC G06F 3/04883; B60K 37/06; G06F 3/165; G06F 3/04886; G06F 3/0482; G06F 3/162; B60K 2350/1028; B60K 2350/1052; G06F 2203/04108

(57) ABSTRACT

A device, system and method for providing a user with feedback on an input. During use, when an input is received, the input is evaluated and classified. Depending on the determined class, an orientation of an interface of a display element displayed on a display unit (IO) is modified.

### RELATED APPLICATIONS

The present application claims priority under 35 U.S.C. §371 to International PCT Application No. PCT/EP2014/051056 to Holger Wild et al., titled “User Interface and Method for Controlling a Volume by Means of a Touch-Sensitive Display Unit” filed Jan. 20, 2014, which is incorporated by reference in its entirety herein.

### TECHNICAL FIELD

The present disclosure relates to a user interface and methods for controlling a volume via a touch-sensitive display unit. In particular, the present disclosure relates to minimizing the display of unnecessary additional buttons and/or minimizing the operating steps to performing volume control.

### BACKGROUND

Various means of transport, such as vehicles, cars, trucks, and the like, are known to have different input means, through which the volume of a sound playback device can be adjusted. In particular, a turning knob is known as an input means, which, when rotated in a first direction decreases the volume and, when rotated in a second direction, increases the volume. In the field of mobile devices (e.g., smart phones, tablet PCs), it is also known to display a sound controller on a screen with a touch-sensitive surface, wherein the operating element of which can be moved by a swipe gesture backwards and forwards.

DE 10 2007 039 445 A1 and DE 10 2009 008 041 A1 disclose user interfaces for vehicles, in which a proximity sensor system is used to switch the menu of a user interface from a display mode to an operating mode. It is proposed, inter alia, to use swipe gestures for influencing a playback of the volume depending on the display elements displayed.

The limited surface area of typical display elements requires an intelligent selection of the information and buttons associated with various functions. The solutions that are known in the prior art always require a display of a volume control, before the volume control can be operated.

### SUMMARY

According to various illustrative embodiments, apparatus, systems and methods are disclosed for controlling a volume and a user interface, which is configured for carrying out related functions. A volume may be controlled via a display unit, which, for example, may include a touch-sensitive surface. Such display units are commonly referred to as touch screens. A plurality of buttons may be displayed on the display unit. In the context of the present disclosure, a “button” may be interpreted to mean an operating element displayed on the display unit which, upon tapping (“click gesture”) causes the execution of an associated function. Subsequently, a swipe gesture may be recognized in front of and/or on a button of the display unit. The recognition in front of the display unit, for example, may be recognized via a proximity sensor system. A swipe gesture on (i.e., contacting) the display unit can be recognized via the touch-sensitive surface. Thus, a swipe gesture may substantially correspond to an essentially linear motion via an input means (e.g., a user's finger, stylus, or the like) carried out parallel to the display surface of the display unit. In some illustrative embodiments, a swiping motion may start, for example, on a first button and extend over one or more other buttons. In response, the volume may be controlled as a function of the swipe gesture. This can be done, for example, similar to a linearly configured volume control (“slider”) without the volume control means having been displayed on the display unit at the beginning of the process (“first contact”) of the swipe gesture. Rather, only in response to the recognition of the swipe gesture on a button not primarily associated with a swipe gesture, the volume change function may be initiated. In this way, available space on the display unit can be advantageously used for other information, without having to dispense with an intuitive and quickly usable possibility of influencing the volume.

### BRIEF DESCRIPTION OF THE DRAWINGS

Various illustrative embodiments are described in detail below with reference to the accompanying drawings. In the drawings:

FIG. 1 shows a schematic view of a vehicle under an illustrative embodiment;

FIG. 2 shows a simulated screen view on a display unit and an operating step under an illustrative embodiment;

FIGS. 3 to 10 are operating steps in connection with a display unit under an illustrative embodiment; and

FIG. 11 is a flowchart showing steps of an illustrative embodiment of a method according to the present disclosure.

### DETAILED DESCRIPTION

The present disclosure is directed to recognizing a tap gesture in the area of a button among a plurality of buttons, and triggering a function associated with the button. As described herein, the buttons may be assigned to a primary function which is not related to the change in volume. Accordingly, a tapping of a button (for example, assigned to a pause function) may not correspond to the changing of the volume. However, a tap gesture on a function associated with a “next track” or “previous track” may naturally change or mute the volume. Under the present disclosure however, the volume function may be configured to change regardless of an interruption or alteration of the reproduced content.

According to some illustrative embodiments, the “tap gesture” may include no movement or a negligible movement parallel to the surface of the display unit. Accordingly, the volume of a current playback may not change, and, instead, a function associated with the button may be triggered. In this example, interactions with a single button may launch different functionalities without any of them being specifically visualized on the button (e.g., by a symbol, “icon”). In this context, functions may be launched regardless of whether the tap gesture is performed in an area in front of the display unit or on (by contacting) the display unit itself.

In some illustrative embodiments, a plurality of buttons may be configured for allowing access to their respective primary functions via a tap gesture. Examples of primary functions include, but are not limited to, “Source selection”, “Track selection”, “Previous track”, “Pause/Play”, “Next track” and “Sound settings”. However, as music playback or, more generally, audio playback, can take place regardless of the currently accessed menu item on the display unit, there may be situations involving displays on the display unit that have nothing to do with an audio playback. In these menus, configurations of the present disclosure may be used for rapid and intuitive changes in volume, so that changing to an audio playback menu for volume changes is not needed. In this way, unnecessary operations steps for changing the volume may be avoided.

In some illustrative embodiments, a volume control may be displayed in response to recognizing a swipe gesture. It may be displayed, for example, at a predefined location and/or below the input means used for carrying out the swipe gesture. The volume control therein is used to help the user orient himself with respect to the current relative volume range and allows additional input gestures for changing the volume.

If the volume control has been faded in, the volume can be controlled as a function of the position of the tap gesture on the volume control, using a tap gesture in the area of the volume control in some illustrative embodiments. In other words, the volume setting may jump to a value linked with the position of the tap gesture. In this way, a further swipe gesture is no longer necessary in the further course of determining the volume setting. The aforementioned tap gesture for setting the volume can also be performed either in an approaching area or in contact with a surface of the display unit.

In some illustrative embodiments, when the user sets a suitable volume, the user may terminate the input by removing the input means from the approaching area. After a predefined period of time after leaving the approaching area, and/or after a final controlling action of the volume, the volume control may be hidden or faded out, respectively. In instances where the display of the volume control has replaced the plurality of buttons (or a sub-plurality of buttons), the (sub-) plurality of buttons may be displayed again on the display unit. If the volume control configuration of the plurality of buttons was only superimposed in a partially transparent view, the plurality of buttons may re-appear after the lapse of the predefined time period. In this way, a further operating step for fading out the volume control can be omitted, whereby the user can, on the one hand, dedicate himself entirely to the task of driving and, on the other hand, a plurality of buttons or functions associated with these buttons can be operated again by the user with relative ease.

If the volume control has been faded in, a double click on the volume control can control the volume to a minimum value (“mute”). In this way, a situation-dependent suppression of audio playback can be achieved in a way that is fast, intuitive and easy. If, upon recognizing the double click, the current volume is already set to a minimum value, in response to recognizing the double-click in front of or on the display unit, the volume can return to a last set (e.g., non-minimum) value. In some illustrative embodiments, this process can be made dependent on whether the minimum value was selected by double-click or whether a swipe gesture occurred to set the minimum value. Particularly in cases when a double click had caused the minimum value, a further double click for overriding the mute function can be very intuitive and quick.

Under some illustrative embodiments, a user interface with a display unit for displaying a plurality of buttons may be utilized. The display unit may, for example, be permanently installed in a vehicle. Such display units are often referred to as central information displays (CID). Alternatively, an instrument cluster may serve as a display unit or be included in the display unit, respectively. Of course, those skilled in the art should recognize that the present disclosure may be configured to be used independently of automotive applications. The user interface may further include an operating unit for gesture recognition, wherein the gestures can take place either in an approaching area in front of the display unit and/or in contact with a surface of the display unit. In some examples, it is only important that a recognized gesture can be recognized as such, and evaluated to the effect as to whether it has been carried out above the plurality of buttons or can be assigned to the plurality of buttons.

Further, a control unit may be provided in the user interface, which sets up the user interface to perform functions described in various illustrative embodiments. The display unit may include a touch-sensitive surface in front of the display unit and/or an LED-based proximity sensor system. In particular, the LED-based proximity sensor system may include infrared LEDs to avoid blinding the user, yet be able to perform reliable gesture recognition. If the user interface is an electronic, portable end device, the display unit, the operating unit and the control unit may be housed in a common housing.

In some illustrative embodiments, the plurality of buttons may have at least one function that is not associated with a music playback control. In other words, in addition to music playback, the user interface can also have other functional scopes to which menus or views displayable on the display unit are assigned. The views not assigned to music playback may also have pluralities of buttons which will perform the method according to the present disclosure upon detecting a swipe gesture input according to the invention.

In some illustrative embodiments, a computer program product comprising instructions is proposed which, when executed by a programmable processor (e.g., a user interface), may cause the processor to perform the steps of a method according to the present disclosure. In some illustrative embodiments, a vehicle comprising a user interface, as described herein, is disclosed.

FIG. 1 shows a vehicle 10 as a means of transport, in the dashboard of which there is arranged a display 1 as a display unit under an illustrative embodiment. In this example, the display 1 is operatively connected by information technology means to an electronic controller 3 as a control unit, which is also operatively connected by information technology means with an infrared LED strip 2 as operating unit. The operation according to the present disclosure is explained in conjunction with the following figures.

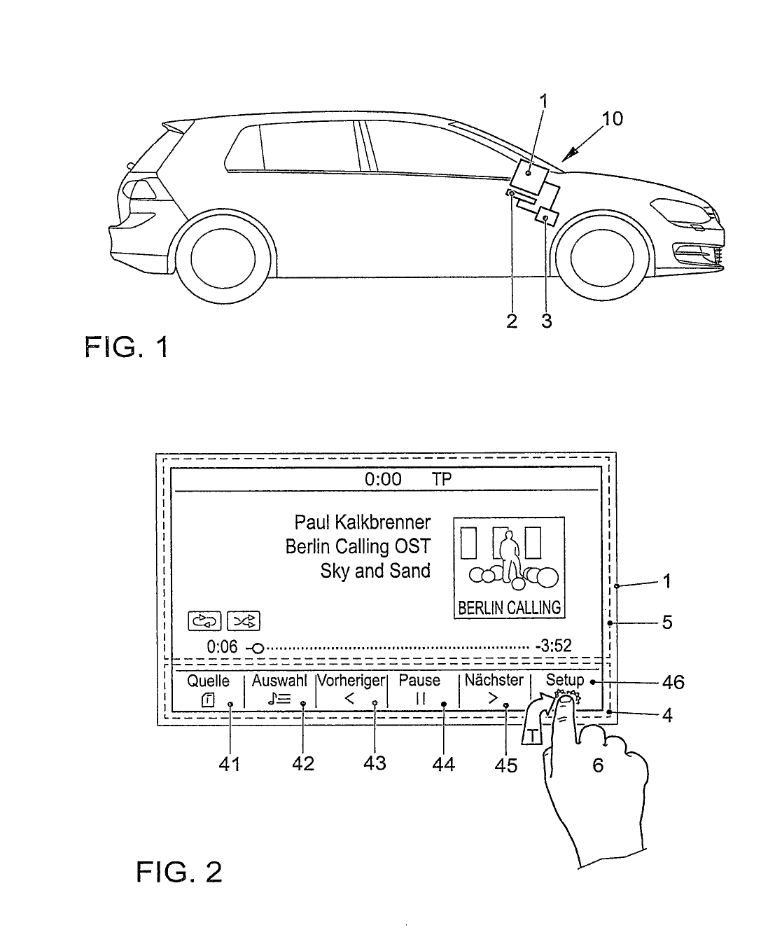

FIG. 2 shows an illustration of a display unit 1, in the upper part of which a main view 5 of a music playback function can be recognized. In this example, an operating bar 4, in the form of a plurality of buttons 41, 42, 43, 44, 45, 46 is arranged below the main view 5. In ascending order, the buttons may be assigned to a source selection, a track selection, a return skip function, a pause/playback function, a “next track” function, as well as a set-up function. During use, the hand 6 of a user performs a tap gesture T with respect to the sixth button 46 and thus launches the display of settings. The setting function may be a primary function that is assigned to the sixth button 46. An operation of the operating bar 4 according to the invention will be explained in connection with the figures below.

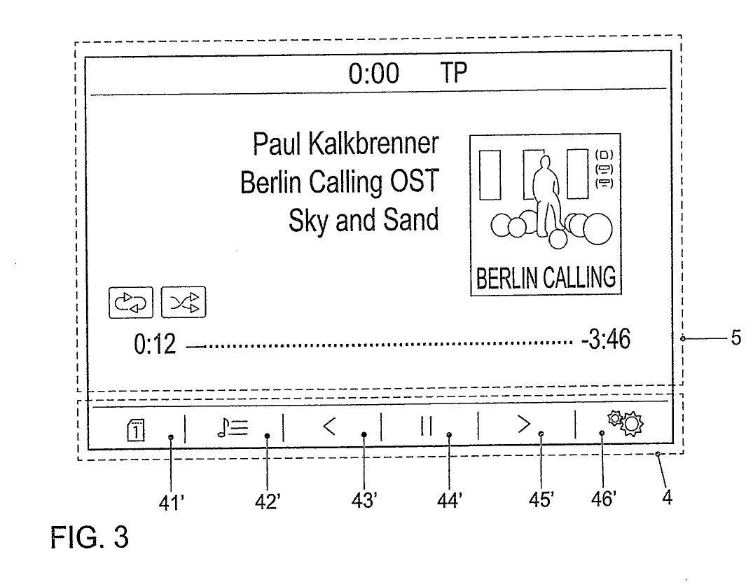

FIG. 3 shows the view shown in FIG. 2 under an illustrative embodiment, wherein the buttons 41, 42, 43, 44, 45, 46 of FIG. 2 are displayed in a reduced level of detail depth in order to save space on the display. Accordingly, in this example, only the icons are displayed on the buttons 41′, 42′, 43′, 44′, 45′, 46′, as long as the user does not hold any input means in the approaching area of the operating unit.

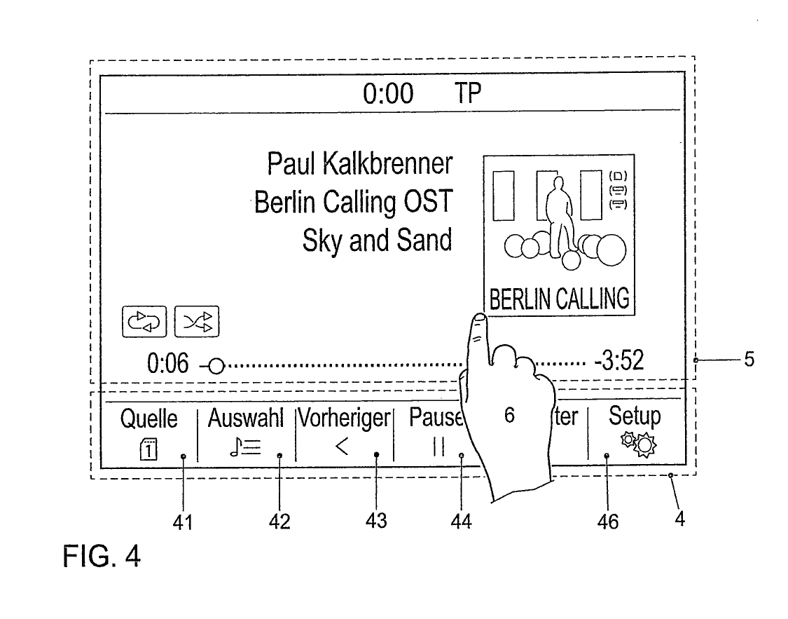

In the example of FIG. 4, the user has moved his hand 6 to the approaching area of the operating unit, in response to which, the extended display of the buttons 41, 42, 43, 44, 45, 46, as introduced in FIG. 2, is used again.

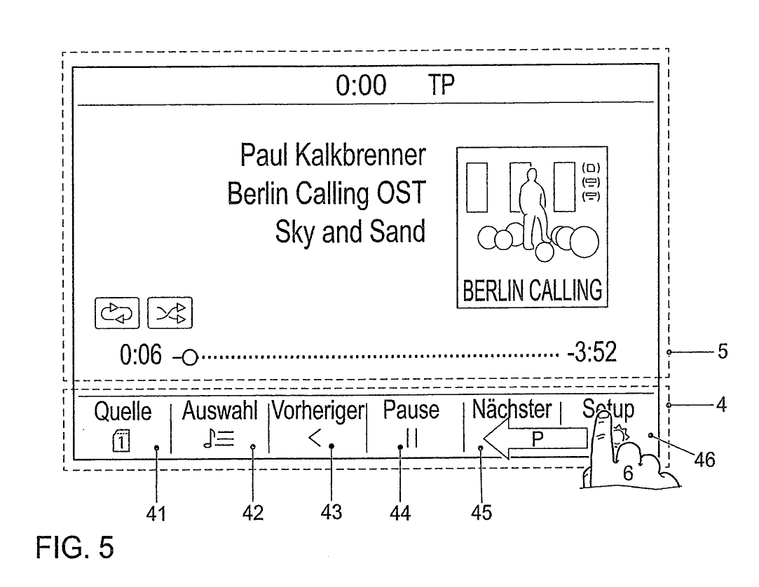

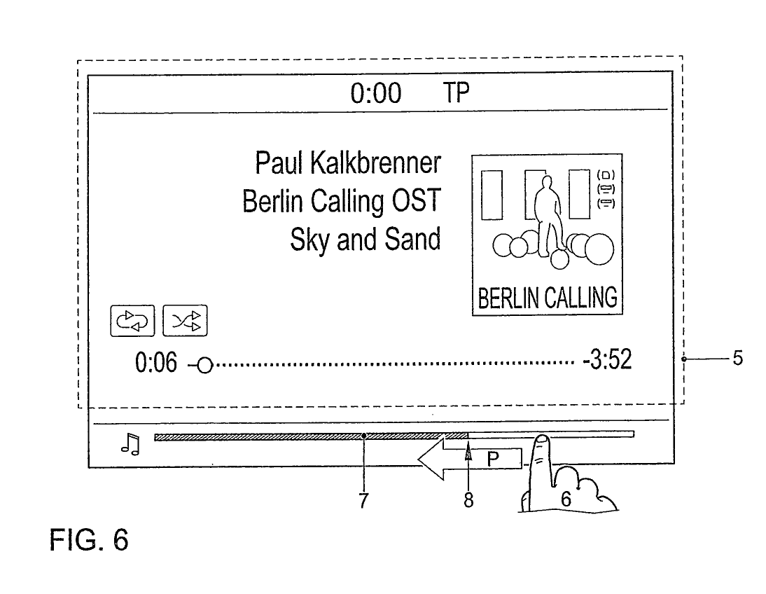

In the example of FIG. 5, the hand 6 of the user starts a swipe gesture oriented in the direction of the arrow P, beginning from the sixth button 46 in the direction of buttons 41, 42, 43, 44, 45 of lower order numbers. Once the swipe gesture P has been detected by the operating unit and recognized by the control unit, a volume control 7 is displayed, as shown in FIG. 6.

In the example of FIG. 6, the user has moved the hand 6, contacting the display 1, to the left to decrease the volume. In response to the recognized swipe gesture P, the volume control 7 is displayed instead of buttons 41, 42, 43, 44, 45, 46. Approximately in the center of the horizontal bar of volume control 7, the current volume 8 is illustrated by a jump in the contrast of the bar. This arises from the fact that, at the start of the swipe gesture, hand 6 of the user has not selected the position on the display 1 correlating with the current volume 8.

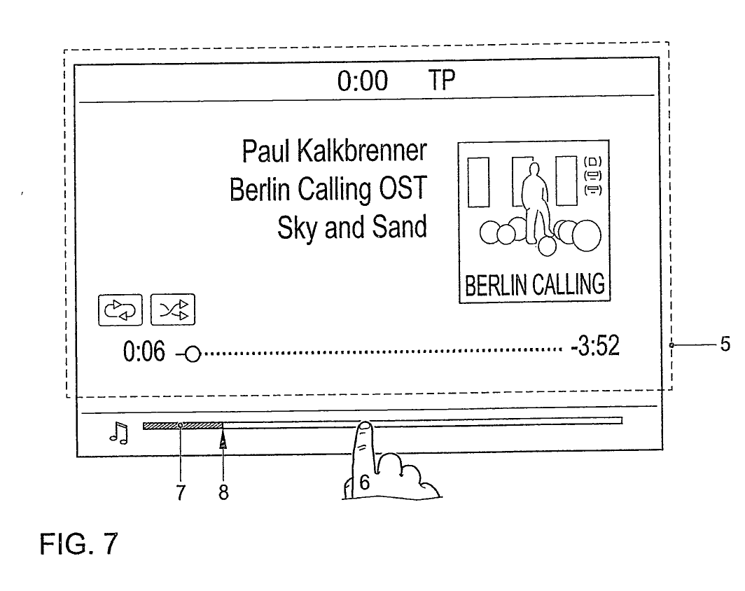

In the example of FIG. 7, the user has set the desired current volume 8. The offset between the position of his hand 6 and the current position 8 has remained constant in this case. Now, the user lifts his hand 6 away from the surface of the display 1.

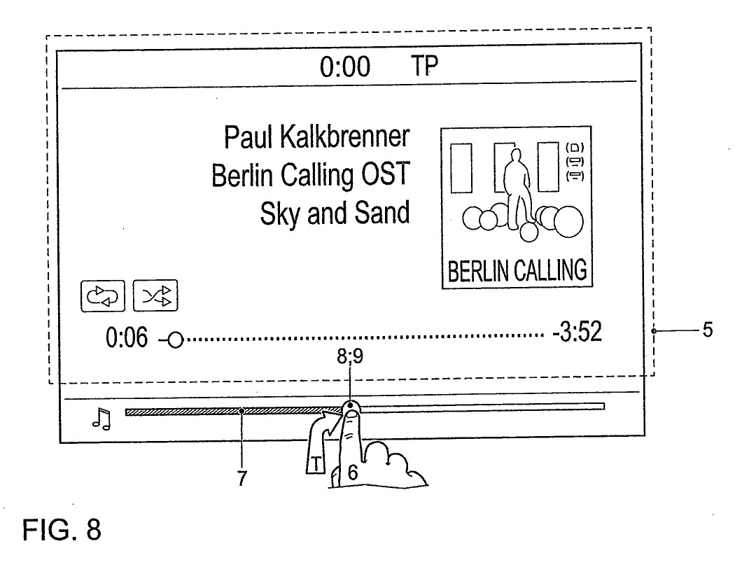

In the example of FIG. 8, the user has expressed his desire for increased playback volume by the fact that he has operated the surface of display 1 in the area of the volume control 7 through a tap gesture T; in response, a control element 9 is displayed at the location of the current volume 8 and both, the operating element 9 and the current volume 8, are displayed according to the current position of the tap gesture T. The user agrees with the currently set volume 8 and lifts, after the operating situation shown in FIG. 8, his hand 6 away from the contact and approaching area of the user interface according to the invention.

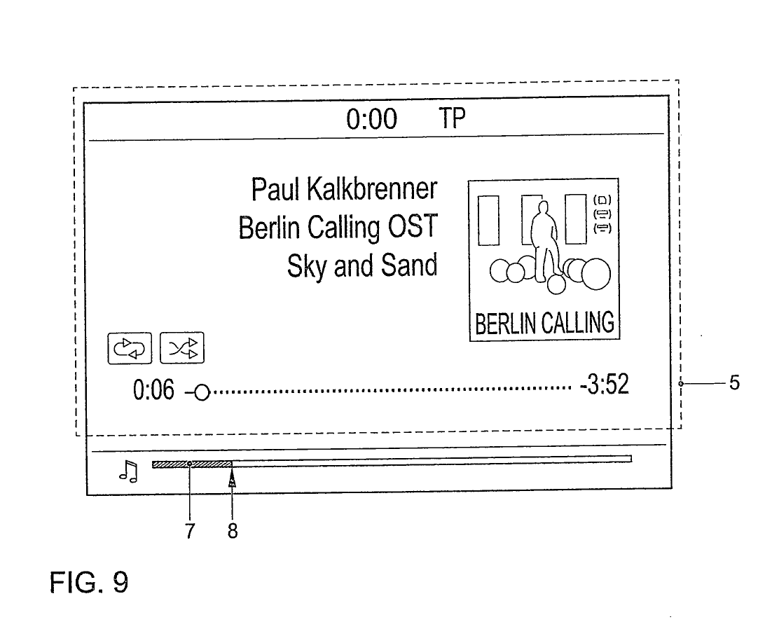

The example of FIG. 9 shows the configuration illustrated in FIG. 8 after removal of the hand 6 of the user from the contact and approaching area of the user interface according to the present disclosure is complete. A timer (not shown) may determine the time which has passed since the hand has left the contact and approaching area.

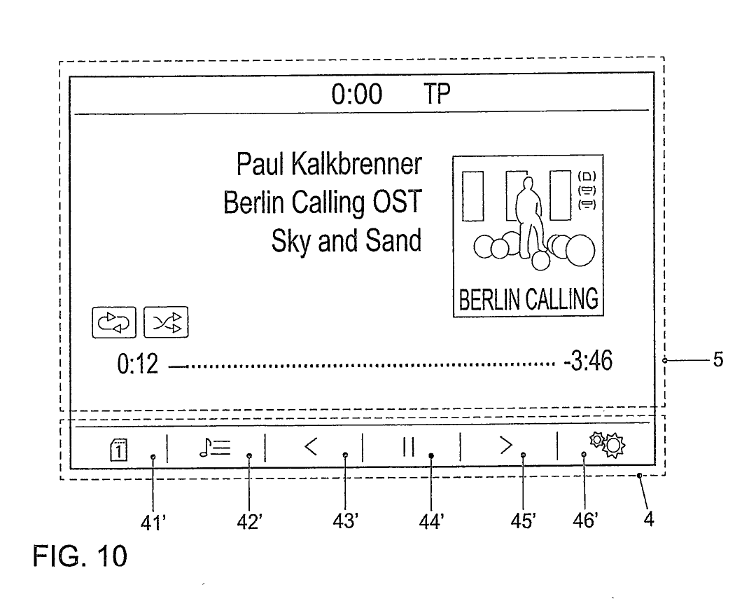

The example of FIG. 10 shows the display illustrated in FIG. 9 after expiry of the timer. Instead of volume control 7, reduced buttons 41′, 42′, 43′, 44′, 45′, 46′ are again displayed on the operating bar 4. A tap gesture in this area would again start primary functions of buttons 41′, 42′, 43′, 44′, 45′, 46, rather than incrementally increasing the current volume value.

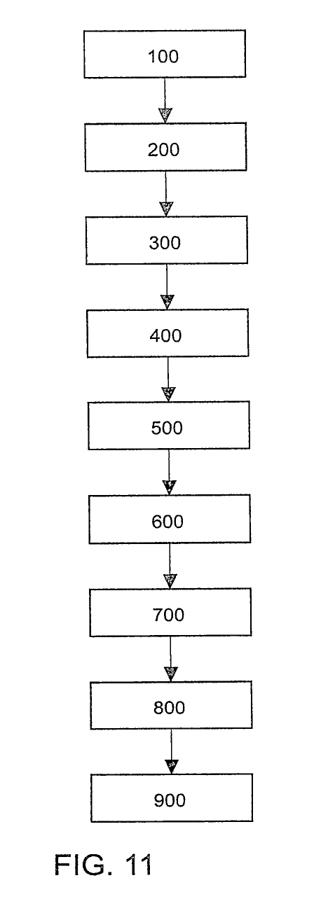

FIG. 11 shows a flow chart illustrating steps of an exemplary embodiment of the present disclosure. Step 100 displays a plurality of buttons on the display unit of a user interface, while, in step 200, a tap gesture is recognized in the area of a button of the plurality of buttons. In response, a function associated with the button, which has been addressed by the tap gesture, is triggered in step 300. Then, in step 400, a swipe gesture in front of and/or on one of the buttons displayed is recognized. In response, the volume of a current audio playback is controlled as a function of the recognized swipe gesture. Also in response to recognizing the swipe gesture (step 400) a volume control is displayed on the display unit in step 600. Subsequently, the user removes the input means from the approaching area of the user interface, which starts a so-called “inactivity timer”. In step 700, the expiry of the “inactivity timer” is recognized, in response to which, in step 800, the volume control is again hidden. Hiding the volume control is accompanied by re-displaying (or fully displaying) the plurality of buttons on the display unit in step 900.

Although the aspects of the invention and advantageous embodiments, which have been described in detail by way of the exemplary embodiments with reference to the accompanying figure and drawings, modifications and combinations of features of the illustrated exemplary embodiments are apparent to persons skilled in the art without departing from the present invention the scope of which is defined by the appended claims.

### LIST OF REFERENCE NUMERALS

1 display
2 infrared LED strip
3 electronic controller
4 operating bar
5 main view
6 the user's hand
7 volume control
8 current volume
9 operating element of the volume control
10 vehicle
41, 42, 43,
44, 45, 46 operating in an extended display
41′, 42′, 43′,
44′, 45′, 46′ buttons in reduced display
100 to 900 steps of the method
P swipe gesture
T tap gesture

1-14. (canceled)

15. A method for controlling a volume for a vehicle via a display unit, comprising:
providing, via the display unit, a plurality of buttons on the display unit, wherein at least some of the plurality of buttons are configured to perform a vehicle function;
detecting, via an operating unit, if a swipe gesture is made in an area of the plurality of buttons that is one of (i) on the display unit or (ii) in front of a surface of the display unit; and
controlling, via the operating unit, the volume in response to the detected swipe gesture.

16. The method of claim 15, further comprising:
detecting, via the operating unit, a tap gesture in the area of a button of the plurality of buttons; and
triggering a function associated with the vehicle, via the operating unit, in response to the recognized tap gesture.

17. The method of claim 15, wherein the plurality of buttons are configured for accessing respective functions for the vehicle when activated by a tap gesture.

18. The method of claim 15, wherein the plurality of buttons are configured as a portion of an operating bar, and are assigned to operating different functions relating to music playback.

19. The method of claim 15, further comprising displaying, via the processing device, a volume control in response to detecting the swipe gesture

20. The method of claim 19, further comprising:
recognizing, via the operating unit, a tap gesture in the area of the displayed volume control; and
controlling, via the operating unit, the volume according to a position of the tap gesture.

21. The method of claim 19, further comprising:
recognizing, via the operating unit, an expiry of a predefined period of time after controlling the volume;
hiding, via the display unit, the volume control; and
re-displaying, via the display unit, at least some of the plurality of buttons on the display unit.

22. The method of claim 19, further comprising:
detecting, via the control unit, a double click on the volume control; and
controlling, via the control unit, the volume to one of (i) a minimum value or (ii) a value set prior to a previous double click on the volume control.

23. A user interface, for controlling a volume for a vehicle via a display unit, comprising:
a display unit for providing a plurality of buttons on the display unit, wherein at least some of the plurality of buttons are configured to perform a vehicle function; and
an operating unit comprising a control unit configured to detect gestures;
wherein the operating unit is configured to detect a swipe gesture made in an area of the plurality of buttons that is one of (i) on the display unit or (ii) in front of a surface of the display unit, and wherein the operating unit is configured to control the volume in response to the detected swipe gesture.

24. The user interface of claim 23, wherein the operating unit is configured to detect a tap gesture in the area of a button of the plurality of buttons and trigger a function associated with the button for the vehicle in response to the recognized tap gesture.

25. The user interface of claim 23, wherein the plurality of buttons are configured for accessing respective functions for the vehicle when activated by a tap gesture.

26. The user interface of claim 23, wherein the plurality of buttons are configured as a portion of an operating bar, and are assigned to operating different functions relating to music playback.

27. The user interface of claim 23, wherein the display unit is configured to display a volume control in response to detecting the swipe gesture.

28. The user interface of claim 27, wherein the operating unit is configured to detect a tap gesture in the area of the displayed volume control and control the volume according to a position of the tap gesture.

29. The user interface of claim 27, wherein the operating unit is configured to detect an expiry of a predefined period of time after controlling the volume, and wherein the display unit is configured to hide the volume control after the expiry of the predefined period of time and re-display at least some of the plurality of buttons.

30. The user interface of claim 27, wherein the operating unit is configured to detect a double click on the volume control and control the volume to one of (i) a minimum value or (ii) a value set prior to a previous double click on the volume control.

31. The user interface of claim 23, wherein the display unit comprises an instrument cluster of the vehicle.

32. The user interface of claim 23, wherein the operating unit comprises one of (i) a touch-sensitive surface in front of the display or (ii) an LED-based proximity sensor system.
